(19) United States
(12) Patent Application Publication
(10) Pub. No.: US 2010/0274369 A1
(43) Pub. Date: Oct. 28, 2010

(54) SIGNAL PROCESSING APPARATUS, SOUND APPARATUS, AND SIGNAL PROCESSING METHOD

(75) Inventors: Yasuhiro KANISHIMA, Tokyo (JP); Toshifumi YAMAMOTO, Tokyo (JP); Norikatsu CHIBA, Kanagawa (JP); Kazuyuki SAITO, Tokyo (JP); Takashi FUKUDA, Saitama (JP)

Correspondence Address: PATTERSON & SHERIDAN, L.L.P., 3040 POST OAK BOULEVARD, SUITE 1500, HOUSTON, TX, 77056, US

(73) Assignee: KABUSHIKI KAISHA TOSHIBA, Tokyo (JP)

(21) Appl. No.: 12/698,736

(22) Filed: Feb. 2, 2010

(30) Foreign Application Priority Data
Apr. 28, 2009 (JP) 2009-109897

(51) Int. Cl. G06F 17/00

(52) U.S. Cl. 700/94

(57) ABSTRACT

According to one embodiment, a signal processing apparatus, includes: an output module configured to output a sound source signal to an external environment; a receiver configured to receive a response signal responding to the sound source signal output by the output module; an extracting module configured to extract a noise component signal from the response signal received by the receiver using an inverse filtering process of a frequency characteristic, the frequency characteristic being set in advance by dividing a measurement response signal responding to a measurement sound source signal used to measure the external environment from the measurement source signal, the measurement source signal being one of the sound source signal output by the output module; and a removing module configured to remove the noise component signal from the sound source signal output by the output module after the extraction of the noise component signal.

### CROSS-REFERENCE TO RELATED APPLICATIONS

This application is based upon and claims the benefit of priority from Japanese Patent Application No. 2009-109897, filed on Apr. 28, 2009, the entire contents of which are incorporated herein by reference.

### BACKGROUND

1. Field

The invention relates to a signal processing apparatus to reduce a noise, a sound apparatus, and a signal processing method.

2. Description of the Related Art

Sound reproducing apparatuses with excellent portability that enable a listener to listen to a reproduced sound, such as music, using a headphone or an earphone have been widely developed. When the listener listens to the music using the headphone or the earphone, it is difficult for the listener to clearly listen to the reproduced sound due to an external noise generated in an external environment. Accordingly, various technologies have been suggested to reduce the external noise.

For example, according to Japanese Patent Application Publication (KOKAI) No. 2000-242277, an external noise is picked up to generate a noise cancellation signal to cancel the external noise, and the external noise is offset by the generated noise cancellation signal. Thereby, since the external noise can be reduced, the listener can clearly listen to the reproduction sound.

However, according to Japanese Patent Application Publication (KOKAI) No. 2000-242277, a noise signal cannot be accurately separated from a sound pickup signal due to frequency characteristics of a sound pickup portion, a sound emitting portion, and an external auditory meatus space, thereby the external noise cannot be sufficiently reduced.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary view of a sound characteristic correcting apparatus according to a first embodiment of the invention;

FIG. 2 is an exemplary view of a structure of an earphone in the first embodiment;

FIG. 3 is an exemplary block diagram of the sound characteristic correcting apparatus in the first embodiment;

FIG. 4 is an exemplary view of a model of a sound region in the case of using the sound characteristic correcting apparatus in the first embodiment;

FIG. 5 is an exemplary flowchart of process until a filter coefficient is set to a first filter in the sound characteristic correcting apparatus in the first embodiment;

FIG. 6 is an exemplary flowchart of process until a sound is output in the sound characteristic correcting apparatus in the first embodiment;

FIG. 7 is an exemplary flowchart of calculating process of a noise component signal in the sound characteristic correcting apparatus in the first embodiment;

FIG. 8 is a block diagram of the configuration of a sound characteristic correcting apparatus according to a second embodiment of the invention; and

FIG. 9 is an exemplary view of the sound characteristic correcting apparatus in the second embodiment.

### DETAILED DESCRIPTION

Various embodiments according to the invention will be described hereinafter with reference to the accompanying drawings. In general, according to one embodiment of the invention, a signal processing apparatus, includes: an output module configured to output a sound source signal to an external environment; a receiver configured to receive a response signal responding to the sound source signal output by the output module; an extracting module configured to extract a noise component signal from the response signal received by the receiver using an inverse filtering process of a frequency characteristic, the frequency characteristic being set in advance by dividing a measurement response signal responding to a measurement sound source signal used to measure the external environment from the measurement source signal, the measurement source signal being one of the sound source signal output by the output module; and a removing module configured to remove the noise component signal from the sound source signal output by the output module after the extraction of the noise component signal.

According to another embodiment of the invention, a sound apparatus, includes: an output module configured to output a sound source signal to an external environment; a receiver configured to receive a response signal responding to the sound source signal output by the output module; an extracting module configured to extract a noise component signal from the response signal received by the receiver using an inverse filtering process of a frequency characteristic, the frequency characteristic being set in advance by dividing a measurement response signal responding to a measurement sound source signal used to measure the external environment from the measurement source signal, the measurement source signal being one of the sound source signal output by the output module; and a removing module configured to remove the noise component signal from the sound source signal output by the output module after the extraction of the noise component signal.

According to still another embodiment of the invention, a signal processing method, includes: an output module outputting a sound source signal to an external environment; a receiver receiving a response signal responding to the sound source signal output by the output module; an extracting module extracting a noise component signal from the response signal received by the receiver using an inverse filtering process of a frequency characteristic, the frequency characteristic being set in advance by dividing a measurement response signal responding to a measurement sound source signal used to measure the external environment from the measurement source signal, the measurement source signal being one of the sound source signal output by the output module; and a removing module removing the noise component signal from the sound source signal output by the output module after the extraction of the noise component signal.

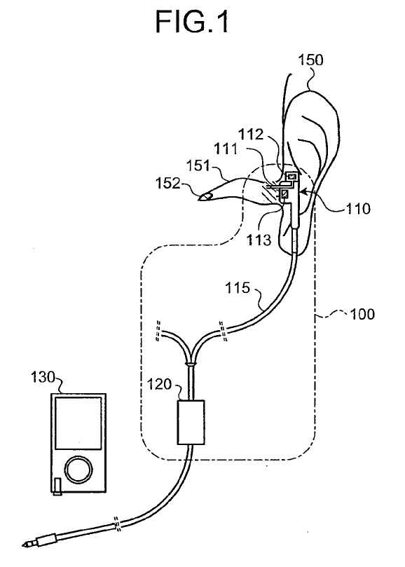

FIG. 1 illustrates a sound characteristic correcting apparatus 100 according to a first embodiment of the invention. In FIG. 1, the sound characteristic correcting apparatus 100 is connected to a sound reproducing apparatus 130 that reproduces a sound source signal. The sound characteristic correcting apparatus 100 includes a casing 120, a signal line 115, and an earphone 110. In FIG. 1, only the earphone 110 at the side of a left ear is illustrated, but an earphone that has the same configuration as that of the left earphone is also provided at the side of a right ear. Thereby, a sound characteristic correcting apparatus that suppresses a noise of each of left (L) and right (R) two channel stereos can be realized.

In the sound reproducing apparatus 130, an internal sound data generator (not illustrated) generates (reproduces) sound data (sound source signal) and outputs the generated sound data to the sound characteristic correcting apparatus 100. The sound characteristic correcting apparatus 100 corrects the received sound data (sound source signal) to suppress a noise, and then outputs the corrected sound source signal from the earphone 110 to an external environment. In the first embodiment, it is assumed that the external environment is an external auditory meatus space of a listener.

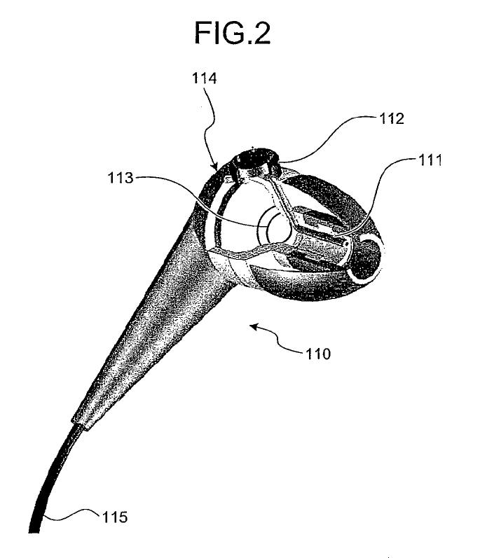

Next, the earphone 110 will be described. FIG. 2 illustrates the structure of the earphone 110. As illustrated in FIG. 2, the earphone 110 includes a speaker 113, a microphone 112, a nozzle 111, and a housing 114.

As illustrated in FIGS. 1 and 2, when the listener mounts the earphone 110 in an external auditory meatus space 151 of a left ear, the speaker 113 is provided at a position corresponding to an eardrum 152 of a left ear 150 of the listener. The housing 114 is formed to encompass the speaker 113.

The nozzle 111 is formed of a pipe (thin shape). In the outside of the housing 114, the microphone 112 is provided at a position where a sound in the external auditory meatus space 151 can be picked up. The reason why the microphone 112 is provided outside the housing 114 is to prevent the microphone 112 from not being directly affected by the sound output from the speaker 113 and from not affecting a characteristic of the sound. The microphone 112 picks up the sound in the external auditory meatus through the nozzle 111. In the first embodiment, the microphone 112 is provided outside the housing 114, however, the microphone 112 may be provided inside the housing 114, as long as the microphone 112 is not directly affected by the sound output from the speaker 113 and does not affect the characteristic of the sound.

In the conventional sound correcting apparatus, sound correcting process is executed by cancelling the sound picked up from the microphone oriented to the outside of the left ear 150. However, in the sound that is picked up from the microphone oriented to the outside of the left ear 150, frequency characteristics of a sound pickup portion (including the microphone 112), a sound emitting portion (including the speaker 113), and the external auditory meatus space 151 are not considered. Accordingly, in the first embodiment, the microphone 112 picks up a sound from the external auditory meatus space 151 through the nozzle 111. Next, the configuration of correcting a sound on the basis of the sound picked up by the microphone 112 will be described.

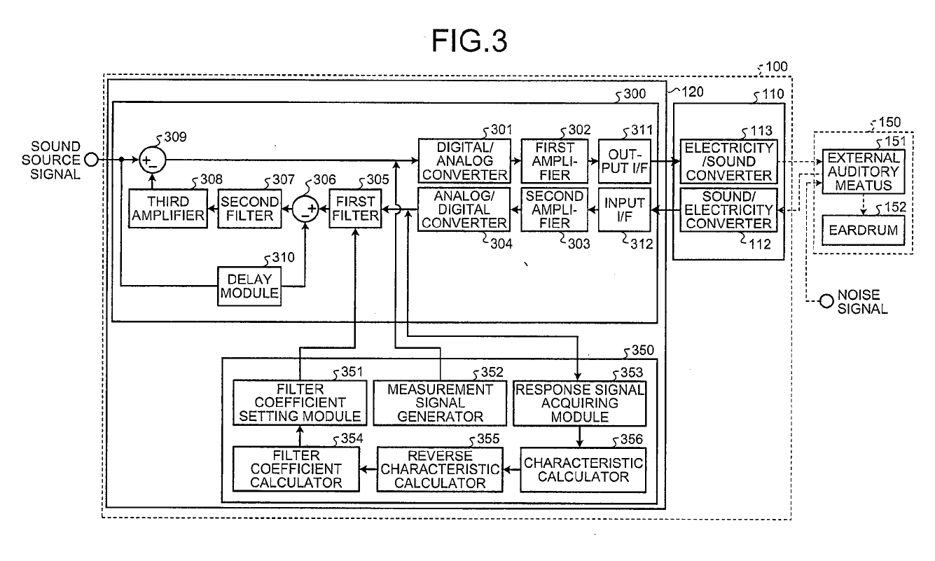

FIG. 3 is a block diagram of the configuration of the sound characteristic correcting apparatus 100 in the first embodiment. As illustrated in FIG. 3, the sound characteristic correcting apparatus 100 includes the casing 120 and the earphone 110.

The earphone 110 includes an electricity/sound converter 113 and a sound/electricity converter 112. The speaker 113 that is illustrated in FIGS. 1 and 2 functions as the electricity/sound converter 113, and the microphone 112 functions as the sound/electricity converter 112.

The electricity/sound converter 113 converts a sound source signal, which is an electric signal received from the casing 120, into a sound, and outputs the sound to the external auditory meatus space 151.

The sound/electricity converter 112 picks up the sound in the external auditory meatus space 151, and converts the picked sound into an electric signal. In the first embodiment, the sound that is converted into the electric signal is used as a (analog) response signal. That is, the sound/electricity converter 112 receives a response signal responding to the sound source signal output by the electricity/sound converter 113, from the external auditory meatus space 151.

In the sound/electricity converter (microphone) 112, a sound that is emitted from the electricity/sound converter (speaker) 113 and a surrounding noise (noise signal) that leaks from a gap of ear chips and arrives at the inside of the external auditory meatus space 151 are picked up. That is, different from the conventional sound correcting apparatus, the sound/electricity converter 112 according to the first embodiment picks up a noise (noise signal) in the external auditory meatus space 151.

The casing 120 includes a correcting module 300 that corrects a sound and a filter coefficient deriving module 350 that calculates, and sets a filter coefficient needed to cause the correcting module 300 to correct the sound. The sound is emitted and picked up by the earphone 110, and noise reducing process is executed by the correcting module 300. The correcting module 300 may be incorporated in the sound reproducing apparatus 130.

In the sound characteristic correcting apparatus 100 according to the first embodiment, two kinds of process modes are prepared. Between the two process modes, in one mode that is a filter coefficient setting mode, frequency characteristics of the sound pickup portion (including the microphone 112), the sound emitting portion (including the speaker 113), and the external auditory meatus space 151 are measured, and a correction coefficient that is used in a first filter 305 is set. In the other mode that is a sound output mode, a sound source signal correcting process is executed by the first filter 305 using the set filter coefficient, and the corrected sound source signal is then output.

Every time the listener mounts the earphone 110, the sound characteristic correcting apparatus 100 enters in the filter coefficient setting mode, and executes process of setting the filter coefficient of the first filter 305 by using the measured frequency characteristics of the external auditory meatus space 151 of the listener, the sound pickup portion (including the microphone 112), and the sound emitting portion (including the speaker 113). After the setting of the filter coefficient is completed, the sound characteristic correcting apparatus 100 enters in the sound output mode. By executing the corresponding process, a noise removing process that considers the frequency characteristic of the external auditory meatus space 151 different for each listener can be executed.

The filter coefficient deriving module 350 includes a filter coefficient setting module 351, a measurement signal generator 352, a response signal acquiring module 353, a filter coefficient calculator 354, an inverse characteristic calculator 355, and a characteristic calculator 356. When the process mode of the sound characteristic correcting apparatus 100 is the filter coefficient setting mode, the filter coefficient deriving module 350 executes a process of setting a filter coefficient.

The measurement signal generator 352 generates a (digital) measurement signal that indicates a digital signal to measure the frequency characteristics of the external auditory meatus space 151 of the listener, the sound pickup portion (including the microphone 112), and the sound emitting portion (including the speaker 113). In the first embodiment, the measurement signal is used as a predetermined digital (electric) signal to measure the frequency characteristics.

The digital measurement signal that is generated by the measurement signal generator 352 passes through a digital/analog converter 301, a first amplifier 302, and an output interface 311 to be described in detail below, is converted into a measurement sound by the electricity/sound converter 113, and is then output to the external auditory meatus space 151.

A response sound (as a reflective sound) that corresponds to the output measurement sound is received by the sound/electricity converter 112. The received response sound is converted into an analog (electric) signal by the sound/electricity converter 112. In the first embodiment, the converted analog (electric) signal is used as an analog response signal. The analog response signal is then converted into a digital signal after passing through an input interface 312, a second amplifier 303, and an analog/digital converter 304, and is acquired by the response signal acquiring module 353. In the first embodiment, the digital signal that is converted from the analog response signal is used as a digital response signal.

As described above, the response signal acquiring module 353 acquires a digital response signal, which corresponds to the measurement sound output by the electricity/sound converter 113, through the sound/electricity converter 112, the input interface 312, the second amplifier 303, and the analog/digital converter 304.

The characteristic calculator 356 divides the digital response signal acquired by the response signal acquiring module 353 from the digital measurement signal generated by the measurement signal generator 352, and calculates the frequency characteristics of the sound emitting portion, the external auditory meatus space, and the sound pickup portion.

Next, a method that uses the characteristic calculator 356 to derive a transfer function of the digital/analog converter 301, the first amplifier 302, and the electricity/sound converter (speaker) 113, a transfer function of the sound/electricity converter (microphone) 112, the second amplifier (microphone) 303, and the analog/digital converter 304, and a transfer function of the external auditory meatus space 151 is exemplified.

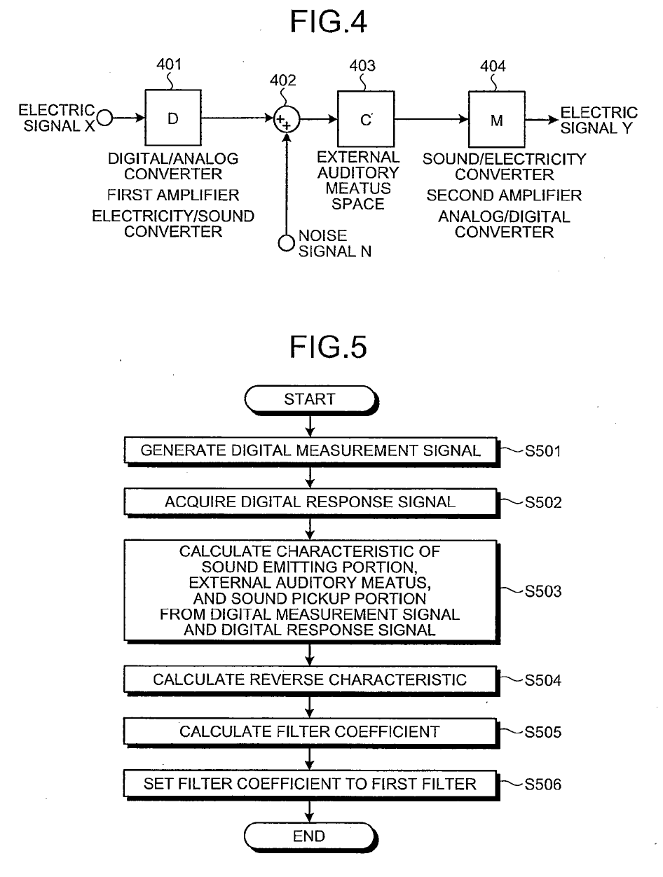

FIG. 4 illustrates a model of a sound region in the case of using the sound characteristic correcting apparatus 100 in the first embodiment. In FIG. 4, a transfer function of a sound emitting portion 401 by the digital/analog converter 301, the first amplifier 302, and the electricity/sound converter 113 is defined as D. A transfer function of a sound pickup portion 404 by the sound/electricity converter 112, the second amplifier 303, and the analog/digital converter 304 is defined as M. A transfer function of the external auditory meatus space 151 (refer to reference numeral 403 of FIG. 4) is defined as C. A noise signal is defined as N. Since the noise signal N is input from a space between the earphone 110 and the left ear 150, the noise signal N is added by an adder 402.

In the external auditory meatus space 151 where a surrounding noise can be ignored, the measurement signal generator 352 generates a measurement signal X (for example, an impulse and a time stretched pulse) corresponding to the measurement signal, and outputs the measurement signal through the sound emitting portion 401. After the sound is picked up by the microphone, the response signal acquiring module 353 acquires an electric signal Y serving as a response signal through the sound pickup portion 404. In this case, the electric signal Y can be represented by the following Equation 1.

Y=D·C·M·X (1)

Since Y/X=D·C·M is satisfied, the characteristic calculator 356 can derive a transfer function of D·C·M (transfer function where the transfer functions of the sound emitting portion, the external auditory meatus space, and the sound pickup portion are synthesized) from Y/X. The characteristic calculator 356 calculates a frequency characteristic from the derived transfer function. In regards to a method of calculating the frequency characteristic of the transfer function, any methods including the known methods may be considered. By using the calculated frequency characteristic during a filtering process, the frequency characteristics of the sound emitting portion, the external auditory meatus space 151, and the sound pickup portion can be considered.

Referring back to FIG. 3, the inverse characteristic calculator 355 calculates an inverse frequency characteristic of the frequency characteristic that is calculated by the characteristic calculator 356.

The filter coefficient calculator 354 calculates a filter coefficient based on the inverse frequency characteristic that is calculated by the inverse characteristic calculator 355. In regards to a method of calculating the filter coefficient, any methods including the known methods may be considered.

The filter coefficient setting module 351 sets the filter coefficient, which is calculated by the filter coefficient calculator 354, to the first filter 305. Thereby, inverse filtering process that considers the frequency characteristics of the sound emitting portion, the external auditory meatus space, and the sound pickup portion is enabled.

The correcting module 300 includes the digital/analog converter 301, the first amplifier 302, the output interface 311, the input interface 312, the second amplifier 303, the analog/digital converter 304, the first filter 305, a first divider 306, a second filter 307, a third amplifier 308, a second divider 309, and a delay module 310. When the process mode of the sound characteristic correcting apparatus 100 is the sound output mode, the correcting module 300 corrects the sound source signal and outputs the corrected signal.

The digital/analog converter 301 converts the digital sound source signal, which is received from the second divider 309, into an analog sound source signal. In the first embodiment, the digital signal that is received as the sound data from the sound reproducing apparatus 130 is used the digital sound source signal.

The first amplifier 302 amplifies the analog sound source signal, which is received from the digital/analog converter 301, with a first amplification factor. The first amplification factor is set as an appropriate value according to each embodiment.

The output interface 311 outputs the amplified analog sound source signal to the electricity/sound converter (speaker) 113 of the earphone 110. Thereby, the analog sound source signal is output as a sound from the electricity/sound converter (speaker) 113.

The electricity/sound converter 113, the digital/analog converter 301, and the first amplifier 302 are configured to output the sound source signal as the sound, and the configuration corresponds to the sound emitting portion.

The sound/electricity converter (microphone) 112 receives a response sound responding to the sound output by the sound emitting portion, and converts the received response sound into an analog response signal corresponding to an analog signal.

The input interface 312 receives the analog response signal that is converted by the sound/electricity converter 112.

The second amplifier 303 amplifies the analog response signal, which is received by the input interface 312, with a second amplification factor. The second amplification factor is set as an appropriate value according to each embodiment.

The analog/digital converter 304 converts the analog response signal, which is amplified by the second amplifier 303, into a digital response signal. The converted digital response signal is output to the first filter 305 or the response signal acquiring module 353.

The sound/electricity converter 112, the analog/digital converter 304, and the second amplifier 303 are configured to generate a response signal from the sound picked from the external auditory meatus space 151, and the configuration corresponds to the sound pickup portion.

That is, in the first embodiment, since the inverse filtering process that considers the frequency characteristics of the sound emitting portion, the external auditory meatus space 151, and the sound pickup portion is executed, a separating process of a noise signal that considers the frequency characteristics of the sound emitting portion, the external auditory meatus space 151, and the sound pickup portion not considered in the conventional sound correcting apparatus can be executed. As a result, the noise signal can be accurately separated as compared with the conventional sound correcting apparatus.

The first filter 305, the first divider 306, the delay module 310, the second filter 307, the third amplifier 308, and the second divider 309 to be described in detail below use the inverse filtering process of the frequency characteristic calculated by dividing the measurement response signal corresponding to the response of the measurement signal from the measurement signal output by the sound emitting portion to extract a noise component signal of a sound source signal output by the sound emitting portion, from a new response signal picked by the sound pickup portion. Next, each configuration of the above components will be described.

The first filter 305 executes a filtering process based on the filter coefficient (filter coefficient derived from an inverse characteristic of a frequency characteristic of Y/X) set by the filter coefficient setting module 351, with respect to the response signal received from the analog/digital converter 304.

The delay module 310 delays and adjusts the digital sound source signal before being emitted by the sound emitting portion.

The first divider 306 divides the digital sound source signal, which is delayed and adjusted by the delay module 310 and from which a response signal is not yet emitted, from the response signal subjected to the inverse filtering process by the first filter 305, and generates a noise component signal. The noise component signal is output to the second filter 307.

The second filter 307 executes a low-pass filtering process for compensating for a phase with respect to the noise component signal that is received from the first divider 306.

The third amplifier 308 amplifies the noise component signal, which is subjected to the low-pass filtering process, with the second amplification factor (determining the noise reduction amount).

The second divider 309 divides the noise component signal amplified (noise signal where a phase is inverted) by the third amplifier 308, from the sound source signal received from the sound reproducing apparatus 130.

The sound source signal from which the noise component signal is divided is emitted through the digital/analog converter 301, the first amplifier 302, the output interface 311, and the electricity/sound converter 113. Thereby, a sound signal from which the noise component signal considering the frequency characteristics of the sound emitting portion, the external auditory meatus space 151, and the sound pickup portion are divided is output.

Next, the sound source signal where the noise is removed will be described. First, the digital sound source signal is defined as S, the noise component signal is defined as N, the transfer function of the sound emitting portion including the electricity/sound converter (speaker) 113, the digital/analog converter 301, and the first amplifier 302 is defined as D, the transfer function of the sound pickup portion including the sound/electricity converter (microphone) 112, the analog/digital converter 304, and the second amplifier 303 is defined as M, the transfer function of the external auditory meatus space 151 is defined as C, the transfer function of the second filter 307 is defined as α, and the amplification factor of the third amplifier 308 is defined as A.

The signal P that is not subjected to the filtering process by the first filter 305 and arrives at the eardrum as in the conventional sound correcting apparatus is represented by the following Equation 2.

$$P = \frac{( 1 + α \cdot A ) \cdot D \cdot C}{1 + α \cdot A \cdot D \cdot C \cdot M} \cdot S + \frac{C}{1 + α \cdot A \cdot D \cdot C \cdot M} \cdot N \qquad ( 2 )$$

Meanwhile, in the sound characteristic correcting apparatus 100 according to the first embodiment, the signal P that is subjected to the filtering process by the first filter 305 and arrives at the eardrum 152 is represented by the following Equation 3.

$$P = D \cdot C \cdot S + \frac{1}{1 + α A} \cdot C \cdot N \qquad ( 3 )$$

Thereby, in the first embodiment, the listener can listen to a clear sound where the noise component signal is reduced 1/(1+αA) times, without deteriorating the sound source signal. However, in order to allow a corollary of an expression illustrated in Equation 3 to be stably operated without being oscillated by a frequency band of a noise reduction object, the following Equation 4 needs to be satisfied.

$$\vert \frac{1}{1 + α A} \vert < 1 \qquad ( 4 )$$

Next, process until the filter coefficient is set to the first filter 305 in the sound characteristic correcting apparatus 100 according to the first embodiment will be described. FIG. 5 is a flowchart illustrating a sequence of the above-described process in the sound characteristic correcting apparatus 100 in the first embodiment.

First, the measurement signal generator 352 generates a measurement signal (S501). Then, the generated measurement signal is output as a measurement sound through the digital/analog converter 301, the first amplifier 302, the output interface 311, and the electricity/sound converter 113.

Then, a sound responding to the measurement sound from the external auditory meatus space 151 is received, and the received (response) sound is output as a digital response signal through the sound/electricity converter 112, the input interface 312, the second amplifier 303, and the analog/digital converter 304.

Next, the response signal acquiring module 353 acquires a digital response signal that is a response of the measurement signal (S502).

Next, the characteristic calculator 356 calculates the frequency characteristics of the sound emitting portion, the external auditory meatus space 151, and the sound pickup portion from the digital measurement signal generated by the measurement signal generator 352 and the digital response signal acquired by the response signal acquiring module 353 (S503).

The inverse characteristic calculator 355 calculates the inverse characteristics of the calculated frequency characteristics (S504).

The filter coefficient calculator 354 then calculates the filter coefficient set to the first filter 305, from the inverse characteristic calculated by the inverse characteristic calculator 355 (S505).

Next, the filter coefficient setting module 351 sets the filter coefficient, which is calculated by the filter coefficient calculator 354, to the first filter 305 (S506).

By the above-described process sequence, the filter coefficient that considers the frequency characteristics of the sound emitting portion, the external auditory meatus space 151, and the sound pickup portion is set to the first filter 305.

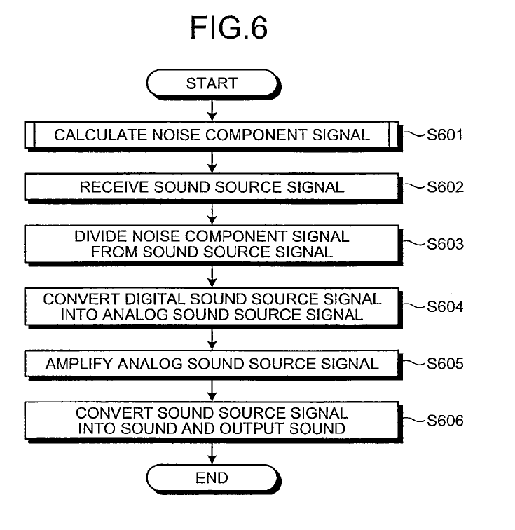

Next, process until the sound in the sound characteristic correcting apparatus 100 according to the first embodiment is output will be described. FIG. 6 is a flowchart illustrating a sequence of the above-described process in the sound characteristic correcting apparatus 100 in the first embodiment.

First, by the configuration of the first filter 305, the first divider 306, the second filter 307, and the third amplifier 308, the noise component signal based on the output sound source signal is extracted to output to the second divider 309 (S601). The detailed process sequence will be described below.

In parallel with the process of S601, the second divider 309 receives the digital sound source signal from the sound reproducing apparatus 130 (S602).

Next, the second divider 309 divides the received noise component signal from the received digital sound source signal (S603).

Next, the digital/analog converter 301 converts the digital sound source signal, from which the noise component signal is divided, into an analog sound source signal (S604). Next, the first amplifier 302 amplifies the analog sound source signal (S605).

Next, the electricity/sound converter 113 converts the amplified analog sound source signal into a sound and outputs the sound (S606).

By the above-described process sequence, the frequency characteristics of the sound emitting portion, the external auditory meatus space 151, and the sound pickup portion are considered and a sound where the noise component signal is removed can be output.

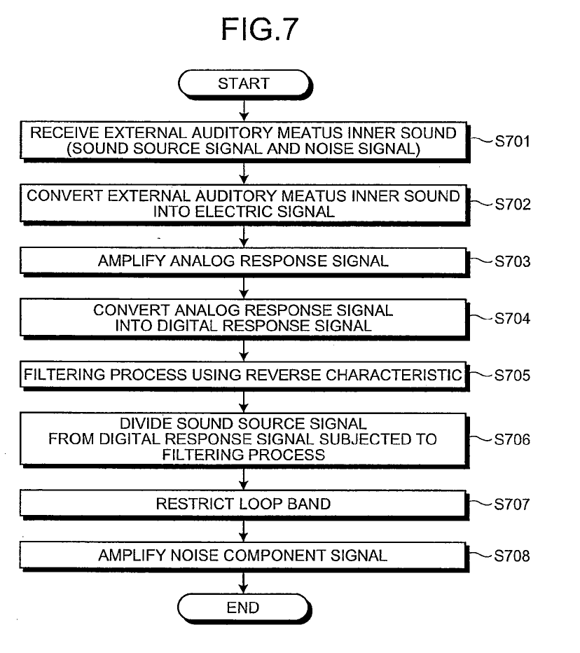

Next, calculating process of the noise component signal illustrated in S601 of FIG. 6 will be described. FIG. 7 is a flowchart illustrating a sequence of the above-described process in the sound characteristic correcting apparatus 100 in the first embodiment.

First, the sound/electricity converter 112 receives an external auditory meatus inner sound from the external auditory meatus space 151 (S701). The external auditory meatus inner sound includes the noise signal and the sound (sound source signal) output by the speaker 113.

Next, the sound/electricity converter 112 converts the received external auditory meatus inner sound into an electric signal (analog response signal) (S702).

Next, the second amplifier 303 amplifies the converted analog response signal (S703).

The analog/digital converter 304 then converts the amplified analog response signal into a digital signal (digital response signal) (S704).

Next, the first filter 305 executes filtering process using inverse characteristics of the frequency characteristics of the sound emitting portion, the external auditory meatus space 151, and the sound pickup portion, with respect to the converted digital response signal (S705). The filter coefficient that is used during the filtering process is set according to the flowchart illustrated in FIG. 5.

The first divider 306 divides the sound source signal delayed by the delay module 310 from the digital response signal subjected to the filtering process, and extracts the noise component signal (S706).

Next, the second filter 307 executes a filtering process to restrict a loop band, with respect to the extracted noise component signal (S707).

Next, the third amplifier 308 amplifies the noise component signal after being subjected to the filtering process (S708).

By the above-described process sequence, the noise component signal is calculated. By the second divider 309, the calculated noise component signal can be divided from the digital sound source signal. Thereby, in consideration of the frequency characteristics of the sound emitting portion, the external auditory meatus space 151, and the sound pickup portion, the noise component signal can be removed from the digital sound source signal.

As descried above, the sound characteristic correcting apparatus 100 according to the first embodiment can remove the noise component signal from the digital sound source signal in consideration of the frequency characteristics of the sound emitting portion, the external auditory meatus space 151, and the sound pickup portion. Accordingly, the noise that arrives at the eardrum can be further suppressed as compared with the conventional sound correcting apparatus.

In the sound characteristic correcting apparatus 100 according to the first embodiment, from a viewpoint of an auditory feeling of the listener being generated with respect to the sound pressure on the eardrum, the noise is picked up at the position close to the eardrum (microphone 112 is disposed in the external auditory meatus), thereby effectively reducing the noise.

In the sound characteristic correcting apparatus 100 according to the first embodiment, since the noise component signal is extracted according to the above-described process sequence, a touch noise can be reduced, in addition to the surrounding noise.

In the sound characteristic correcting apparatus 100 according to the first embodiment, since the sound is picked up from the external auditory meatus space 151, a mechanism for correcting resonance generated in the external auditory meatus space 151 on the basis of the sound pickup result can be further comprised. As a result, the noise component signal can be removed, and the resonance in the external auditory meatus space 151 of the listener can be corrected.

In the sound characteristic correcting apparatus 100 according to the first embodiment, the noise can be effectively reduced by considering the frequency characteristics of the sound emitting portion, the sound pickup portion, and the external auditory meatus space 151.

As described above, in the sound characteristic correcting apparatus 100 according to the first embodiment, the noise component signal is removed by a digital circuit, and the inverse filtering process based on the frequency characteristics is enabled in the external auditory meatus space 151 of the listener by changing the above-described process mode without a physical component element exchange. As a result, various individual differences of the listeners or the state variation of when the earphone 110 is mounted can be corrected.

In the following, a sound characteristic correcting apparatus according to the second embodiment, which can further remove a noise, is exemplified.

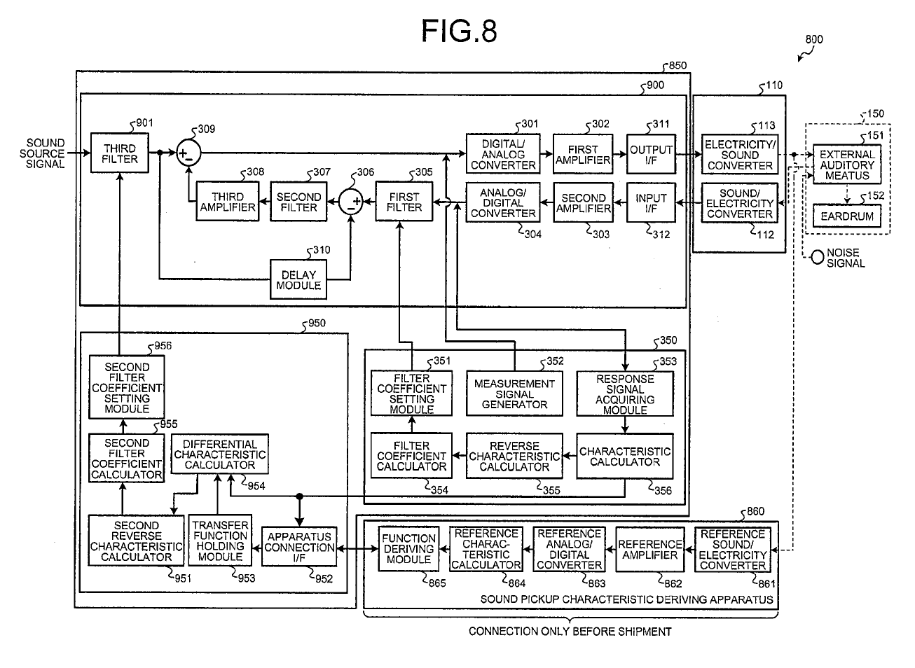

FIG. 8 is a block diagram of the configuration of a sound characteristic correcting apparatus 800 according to the second embodiment. As illustrated in FIG. 8, the sound characteristic correcting apparatus 800 includes a casing 850 and the earphone 110. The sound characteristic correcting apparatus 800 according to the second embodiment is different from the sound characteristic correcting apparatus 100 according to the first embodiment in that process of the casing 850 is different from the process of the casing 120. Also, the sound characteristic correcting apparatus 800 is connected to a sound pickup characteristic deriving apparatus 860 that derives a transfer function M of a frequency of the sound pickup portion before a shipment.

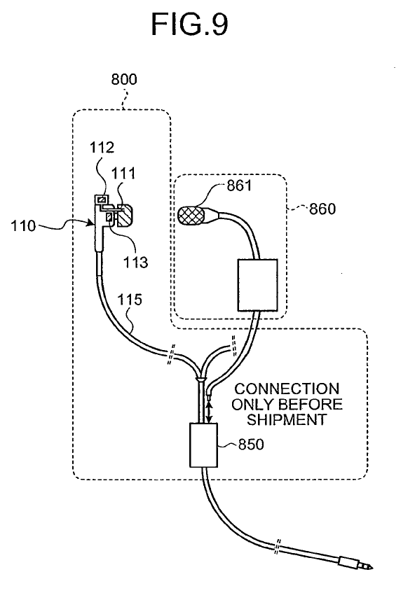

FIG. 9 illustrates an example of the sound characteristic correcting apparatus 800 that is connected to the sound pickup characteristic deriving apparatus 860 before the shipment.

As illustrated in FIG. 9, the sound pickup characteristic deriving apparatus 860 includes a reference microphone 861. The reference microphone 861 is a high-quality microphone where a frequency characteristic is uniform. A speaker 113 of the earphone 110 outputs a measurement sound. Then, each of the reference microphone 861 and the microphone 112 picks up a sound of a response of the measurement sound. The sound pickup characteristic deriving apparatus 860 then calculates a characteristic (transfer function) of the sound pickup portion of the sound characteristic correcting apparatus 800 from a difference of sound pickup results of a reference sound pickup portion including the reference microphone 861 and a sound pickup portion including the microphone 112 of the earphone 110, and holds the calculated characteristic (transfer function) in the casing 850 of the sound characteristic correcting apparatus 800. Then, the sound pickup characteristic deriving apparatus 860 is separated from the sound characteristic correcting apparatus 800.

Referring back to FIG. 8, the configuration of the sound pickup characteristic deriving apparatus 860 will now be described.

The sound pickup characteristic deriving apparatus 860 includes a reference sound/electricity converter (reference microphone) 861, a reference amplifier 862, a reference analog/digital converter 863, a reference characteristic calculator 864, and a function deriving module 865.

The reference sound/electricity converter (reference microphone) 861 picks up a sound of an external environment and converts the picked sound into an electric signal.

The reference amplifier 862 amplifies an analog response signal received from the reference sound/electricity converter 861 with a fourth amplification factor. The fourth amplification factor is set as an appropriate value according to each embodiment.

The reference analog/digital converter 863 converts the analog response signal amplified by the reference amplifier 862 into a digital response signal. The converted digital response signal is output to the reference characteristic calculator 864.

In the second embodiment, the reference sound/electricity converter 861, the reference amplifier 862, and the reference analog/digital converter 863 correspond to the reference sound pickup portion where a frequency characteristic is uniform over the entire band.

The reference characteristic calculator 864 divides the digital response signal received from the reference analog/digital converter 863 from the (digital) measurement signal generated by the measurement signal generator 352 as the measurement sound, and calculates transfer functions of the sound emitting portion, the external auditory meatus space, and the reference sound pickup portion. The (digital) measurement signal that is generated by the measurement signal generator 352 may be held in the reference characteristic calculator 864 in advance or received from the sound characteristic correcting apparatus 800 through an apparatus connection I/F 952.

Meanwhile, since the frequency characteristic of the reference sound pickup portion is uniform over the entire band, the “transfer functions of the sound emitting portion, the external auditory meatus space, and the reference sound pickup portion” calculated by the reference characteristic calculator 864 are almost equal to the “transfer functions of the sound emitting portion and the external auditory meatus space”. Accordingly, the function deriving module 865 according to the second embodiment uses the calculated transfer functions as the transfer functions of the “sound emitting portion and the external auditory meatus space” during the process.

The function deriving module 865 derives the transfer function M of the sound emitting portion (sound/electricity converter 112, the second amplifier 303, and the analog/digital converter 304) from a difference of the transfer function received through the apparatus connection I/F 952 and calculated by the characteristic calculator 356 and the transfer function calculated by the reference characteristic calculator 864.

The transfer function M that is derived by the function deriving module 865 is output to a transfer function holding module 953 through the apparatus connection I/F 952. The transfer function holding module 953 keeps holding the received transfer function M. The connection state of the sound characteristic correcting apparatus 800 and the sound pickup characteristic deriving apparatus 860 is then released. After the sound characteristic correcting apparatus 800 is shipped, the transfer function M that is held by the transfer function holding module 953 is used whenever the filter coefficient is set to a third filter 901.

The casing 850 includes a correcting module 900 that corrects a sound, the filter coefficient deriving module 350 that calculates and sets a filter coefficient for the first filter 305 of the correcting module 900, and a second filter coefficient deriving module 950 that calculates and sets a filter coefficient for the third filter 901 of the correcting module 900.

The correcting module 900 includes the third filter 901, in addition to the components of the correcting module 300 according to the first embodiment.

The third filter 901 executes the filtering process based on the filter coefficient, which is set by a second filter coefficient setting module 956 to be described in detail below, with respect to a digital sound source signal immediately after being input to an input terminal.

During the filtering process that is executed by the third filter 901, inverse filtering process of frequency characteristics of the transfer function D of the sound emitting portion and the transfer function C of the external auditory meatus space 151 is executed. Thereby, the sound signal P that arrives at the eardrum can be represented by the following Equation 5.

$$P = S + \frac{1}{1 + α A} \cdot C \cdot N \qquad ( 5 )$$

As illustrated in Equation 5, since the frequency characteristics of the sound emitting portion and the external auditory meatus space are corrected, the sound source signal can be surely received on the eardrum.

In the second embodiment, the frequency characteristics of the sound emitting portion and the external auditory meatus space 151 can be derived by calculating a difference of the frequency characteristic of the sound pickup portion from the frequency characteristics of the sound emitting portion, the external auditory meatus space 151, and the sound pickup portion calculated in the first embodiment. The frequency characteristic of the sound pickup portion can be derived from the transfer function M that is held by the transfer function holding module 953.

The second filter coefficient deriving module 950 that is needed to set the filter coefficient to the third filter 901 will now be described.

The second filter coefficient deriving module 950 includes the second filter coefficient setting module 956, a second filter coefficient calculator 955, a differential characteristic calculator 954, the transfer function holding module 953, the apparatus connection I/F 952, and a second inverse characteristic calculator 951. The second filter coefficient deriving module 950 sets the filter coefficient to the third filter 901.

The filter coefficient of the third filter 901 is set by the second filter coefficient deriving module 950, when the process mode is the filter coefficient setting mode as described above.

The apparatus connection I/F 952 is an interface that is connected to the sound pickup characteristic deriving apparatus 860 and inputs and outputs a signal (for example, (digital) measurement signal) or a transfer function. The apparatus connection I/F 952 maybe covered and shielded such that the user cannot use the apparatus connection I/F 952 after the shipment.

The transfer function holding module 953 holds the transfer function M of the sound pickup portion of the sound characteristic correcting apparatus 800 that is received from the sound pickup characteristic deriving apparatus 860.

The differential characteristic calculator 954 derives the frequency characteristics of the transfer functions D and C of the sound emitting portion and the external auditory meatus space 151, respectively, from a difference of the transfer functions D, C, and M of the sound emitting portion, the external auditory meatus space 151, and the sound pickup portion derived in the first embodiment and the transfer function M held by the transfer function holding module 953.

The second inverse characteristic calculator 951 calculates the inverse frequency characteristics of the frequency characteristics of the sound emitting portion and the external auditory meatus space 151 that are derived by the differential characteristic calculator 954.

The second filter coefficient calculator 955 calculates a filter coefficient based on the inverse characteristic calculated by the second inverse characteristic calculator 951. In regards to a method of calculating the filter coefficient, any methods including the known methods may be considered.

The second filter coefficient setting module 956 sets the filter coefficient, which is calculated by the second filter coefficient calculator 955, to the third filter 901. Thereby, the inverse filtering process that considers the frequency characteristics of the sound emitting portion and the external auditory meatus space is enabled.

In the sound characteristic correcting apparatus 800 according to the second embodiment that has the above-described configuration, the frequency characteristic of the sound emitting portion (the digital/analog converter 301, the first amplifier 302, and the electricity/sound converter 113) and the frequency characteristic of the external auditory meatus space 151 are corrected, and the sound can be clearly listened on the eardrum.

A sound characteristic correcting program that is executed by the sound characteristic correcting apparatuses according to the above-described embodiments is incorporated in a ROM in advance and provided.

The sound characteristic correcting program that is executed by the sound characteristic correcting apparatuses according to the above-described embodiments may be recorded in computer readable recording media, such as a CD-ROM, a flexible disk (FD), a CD-R, and a DVD (Digital Versatile Disk), in a form of a file having an installable format or an executable format, and provided.

The sound characteristic correcting program that is executed by the sound characteristic correcting apparatuses according to the above-described embodiments may be configured to be stored in a computer connected to a network, such as the Internet, and may be provided by downloading through the network. The sound characteristic correcting program that is executed by the sound characteristic correcting apparatuses according to the above-described embodiments may also be configured to be provided or distributed through the network, such as the Internet.

The sound characteristic correcting program that is executed by the sound characteristic correcting apparatuses according to the above-described embodiments has the module configuration that includes the above-described individual components. When a CPU (processor) that is actual hardware reads and executes the sound characteristic correcting program from the ROM, the individual components are loaded on a main storage apparatus and generated thereon.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A signal processing apparatus, comprising:
an output module configured to output a sound source signal to an external environment;
a receiver configured to receive a response signal responding to the sound source signal output by the output module;
an extracting module configured to extract a noise component signal from the response signal received by the receiver using an inverse filtering process of a frequency characteristic, the frequency characteristic being set in advance by dividing a measurement response signal responding to a measurement sound source signal used to measure the external environment from the measurement source signal, the measurement source signal being one of the sound source signal output by the output module; and
a removing module configured to remove the noise component signal from the sound source signal output by the output module after the extraction of the noise component signal.

2. The signal processing apparatus of claim 1, wherein the extracting module includes:
a filtering process module configured to execute the inverse filtering process of the frequency characteristic with respect to the response signal;
a delay module configured to delay the sound source signal; and
a dividing module configured to divide the sound source signal delayed by the delay module from the response signal subjected to the inverse filtering process by the filtering process module, and generate the noise component signal.

3. The signal processing apparatus of claim 1, further comprising:
a signal generator configured to generate the measurement sound source signal;
an acquiring module configured to acquire the measurement response signal responding to the measurement sound source signal output by the output module through the receiver;
a characteristic calculator configured to divide the measurement response signal acquired by the acquiring module from the measurement sound source signal generated by the signal generator, and calculate frequency characteristics of the output module, the external environment, and the receiver; and
an inverse characteristic calculator configured to calculate inverse frequency characteristics of the frequency characteristics calculated by the characteristic calculator,
wherein the extracting module executes the inverse filtering process using a filter coefficient based on the inverse frequency characteristics calculated by the inverse characteristic calculator.

4. The signal processing apparatus of claim 1, further comprising: a signal filtering module configured to execute the inverse filtering process of the frequency characteristic of the receiver and the external environment with respect to the sound source signal before the noise component signal is removed by the removing module.

5. The signal processing apparatus of claim 1, wherein the external environment where the output module outputs the sound source signal is an external auditory meatus space.

6. A sound apparatus, comprising:
an output module configured to output a sound source signal to an external environment;
a receiver configured to receive a response signal responding to the sound source signal output by the output module;
an extracting module configured to extract a noise component signal from the response signal received by the receiver using an inverse filtering process of a frequency characteristic, the frequency characteristic being set in advance by dividing a measurement response signal responding to a measurement sound source signal used to measure the external environment from the measurement source signal, the measurement source signal being one of the sound source signal output by the output module; and
a removing module configured to remove the noise component signal from the sound source signal output by the output module after the extraction of the noise component signal.

7. A signal processing method, comprising:
an output module outputting a sound source signal to an external environment;
a receiver receiving a response signal responding to the sound source signal output by the output module;
an extracting module extracting a noise component signal from the response signal received by the receiver using an inverse filtering process of a frequency characteristic, the frequency characteristic being set in advance by dividing a measurement response signal responding to a measurement sound source signal used to measure the external environment from the measurement source signal, the measurement source signal being one of the sound source signal output by the output module; and
a removing module removing the noise component signal from the sound source signal output by the output module after the extraction of the noise component signal.
